(19) United States
(12) Patent Application Publication
(10) Pub. No.: US 2011/0157015 A1
(43) Pub. Date: Jun. 30, 2011

(54) METHOD OF GENERATING MULTI-TOUCH SIGNAL, DONGLE FOR GENERATING MULTI-TOUCH SIGNAL, AND RELATED CONTROL SYSTEM

(75) Inventors: Zhou Ye, Foster City, CA (US); Shun-Nan Liou, Kaohsiung City (TW); Ching-Lin Hsieh, Taoyuan County (TW); Wen-Hao Chang, Hsinchu County (TW)

(73) Assignee: CYWEE GROUP LIMITED, Taipei (TW)

(21) Appl. No.: 12/757,046

(22) Filed: Apr. 9, 2010

Related U.S. Application Data
(60) Provisional application No. 61/290,174, filed on Dec. 25, 2009.

(51) Int. Cl. G09G 5/08

(52) U.S. Cl. 345/158

(57) ABSTRACT

A dongle includes: a receiver, for receiving a control signal which is not generated from a multi-touch panel; a processing unit, coupled to the receiver, for generating a multi-touch output signal corresponding to a multi-touch event according to the control signal; and a data port, coupled to the processing unit, for outputting the multi-touch output signal.

### CROSS REFERENCE TO RELATED APPLICATIONS

This application claims the benefit of U.S. provisional application No. 61/290,174, which was filed on Dec. 25, 2009 and is included herein by reference.

### BACKGROUND OF THE INVENTION

1. Field of the Invention

The present invention relates to a control system for simulating a multi-touch panel, and more particularly to a dongle for generating a multi-touch signal sent to a computer, and method thereof.

2. Description of the Prior Art

A computing system having a touch panel may allow a user to make selections and move a cursor by simply touching the display screen via a finger or stylus. In general, the touch screen can recognize the touch and position of the touch on the display screen, and the computing system can interpret the touch and thereafter perform an action based on the touch event. A multi-touch panel is also set up in the computing system to perform multi-touch control of the computing system. Meanwhile, there are many applications/programs launching into the market for increasing entertainment and functionality of the touch panel. For example, Microsoft has realized an operating system (OS), Windows 7, which includes multi-touch functionality. When pairing the Windows 7 OS with a touch-screen computer, users are able to browse on the Internet, flick through photo albums, and shuffle files and folders with their fingers. However, personal computers and laptops may not be equipped with touch panels. Therefore, providing an alternative option for users whose computers/laptops are not equipped with touch panels to be able to use the multi-touch applications provided by the OS, for example, Windows 7, on their original computers/laptops is a significant concern in this field.

### SUMMARY OF THE INVENTION

One of the objectives of the present invention is to provide a controlling system, a dongle for generating a multi-touch signal to a computer, and methods thereof.

According to a first embodiment of the present invention, a dongle is provided. The dongle comprises a receiver, a processing unit, and a data port. The receiver is utilized for receiving a control signal which is not generated from a multi-touch panel. The processing unit is coupled to the receiver for generating a multi-touch output signal corresponding to a multi-touch event according to the control signal. The data port is coupled to the processing unit for outputting the multi-touch output signal.

According to a second embodiment of the present invention, a controlling system dongle is provided. The controlling system comprises a controller and a dongle. The controller is utilized for generating a control signal according to movement information of the controller. The dongle is utilized for receiving the control signal and outputting a multi-touch output signal according to the control signal.

According to a third embodiment of the present invention, a method of generating a multi-touch output signal is provided. The method comprises the steps of: receiving a control signal which is not generated from a multi-touch panel; generating the multi-touch output signal corresponding to a multi-touch event according to the control signal; and outputting the multi-touch output signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controlling system for performing a multi-touch control upon a computer according to an embodiment of the present invention.

FIG. 2 is a flowchart illustrating a method of wirelessly generating a multi-touch event on a monitor of the computer according to an embodiment of the present invention.

FIG. 3 is a diagram illustrating multi-touch events of dragging, scrolling, paging up, and paging down according to an embodiment of the present invention.

FIG. 4 is a diagram illustrating multi-touch events of zooming in, zooming out, clockwise rotating, and anticlockwise rotating according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

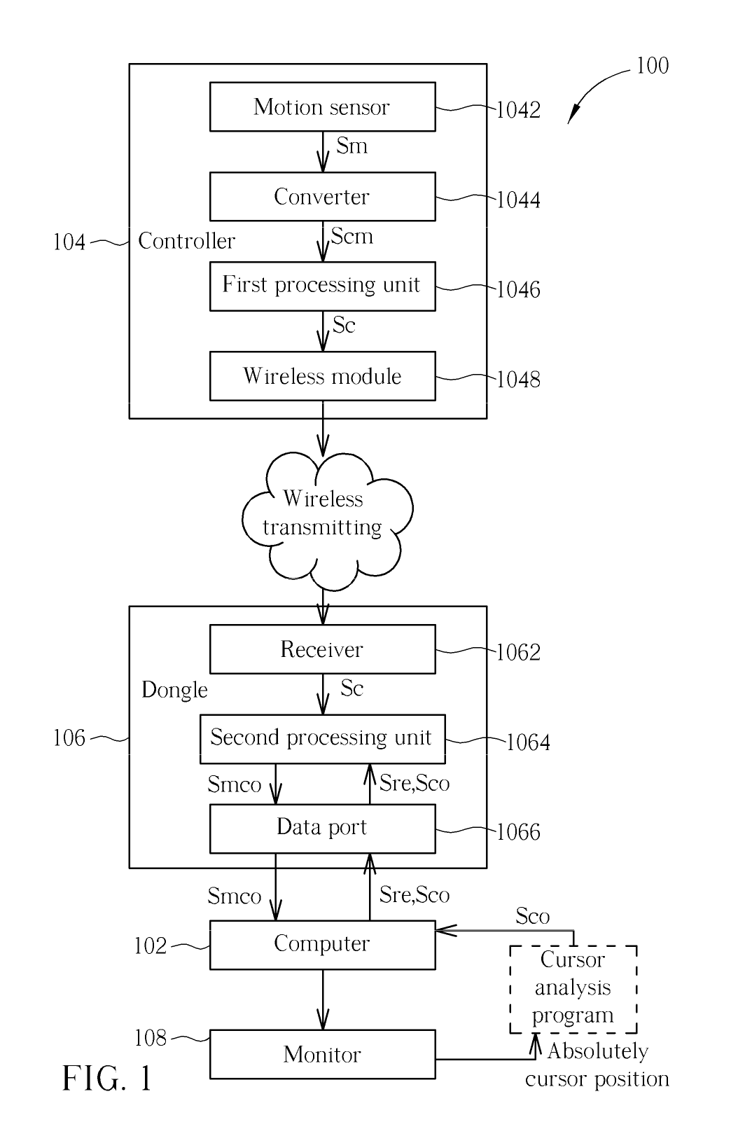

Please refer to FIG. 1. FIG. 1 is a diagram illustrating a controlling system 100 for performing a multi-touch control upon a computer 102 according to an embodiment of the present invention. The controlling system 100 comprises the computer 102, a controller 104 and a dongle 106. When the controlling system 100 is under operation, the dongle 106 is coupled to the computer 102, and the controller 104 communicates with the dongle 106 wirelessly. The controller 104 generates a control signal Sc according to movement information of the controller 104. The dongle 106 receives the control signal Sc and outputs a multi-touch output signal Smco according to the control signal Sc. In this embodiment, the controller 104 comprises a motion sensor 1042, a converter 1044, a first processing unit 1046, and a wireless module 1048. The motion sensor 1042 senses a movement of the controller 104 to generate a motion signal Sm. The converter 1044 is coupled to the motion sensor 1042 for converting the motion signal Sm into a converted motion signal Scm. The first processing unit 1046 is coupled to the converter 1044 for generating the control signal Sc according to the converted motion signal Scm. The wireless module 1048, which is a transmitter, is coupled to the first processing unit 1046 for wireless transmitting the control signal Sc to the dongle 106.

In addition, the dongle 106 comprises a receiver 1062, a second processing unit 1064, and a data port 1066. The receiver 1062 receives the control signal Sc, which is not generated from a multi-touch panel. The second processing unit 1064 is coupled to the receiver 1062 for generating the multi-touch output signal Smco corresponding to a multi-touch event according to the control signal Sc. The data port 1066 is coupled to the second processing unit 1064 for outputting the multi-touch output signal Smco. When the dongle 106 is coupled to the host (i.e., the computer 102) through the data port 1066, the second processing unit 1064 further performs an initialization operation to declare that the dongle 106 is a multi-touch panel. Furthermore, when the dongle 106 is coupled to the computer 102 through the data port 1066, the data port 1066 further receives information of the display resolution Sre from the computer 102 and a coordinate Sco of a cursor displayed on a monitor 106 of the computer 102. Then, the second processing unit 1064 converts the control signal Sc into the multi-touch output signal Smco according to the display resolution Sre of the monitor 106 and the coordinate Sco of the cursor displayed on the monitor 106. It should be noted that, in this embodiment, the receiver 1062 is a wireless receiver, and the data port 1066 is, but not limited to, a Universal Serial Bus (USB) port.

Furthermore, the controller 104 may comprise a button, which is utilized to control the controller 104 to generate an auxiliary signal Sau when the button is pressed by the user, wherein the auxiliary signal Sau is utilized for performing some specific multi-touch events, such as dragging, zooming in/out, or rotating a specific object (e.g., a picture) displayed on the monitor 108 of the computer 102. Therefore, the control signal Sc may further comprise the auxiliary signal Sau generated from the wireless module 1048, and the second processing unit 1064 may generate the multi-touch output signal Smco according to a combination of the auxiliary signal Sau and the movement information.

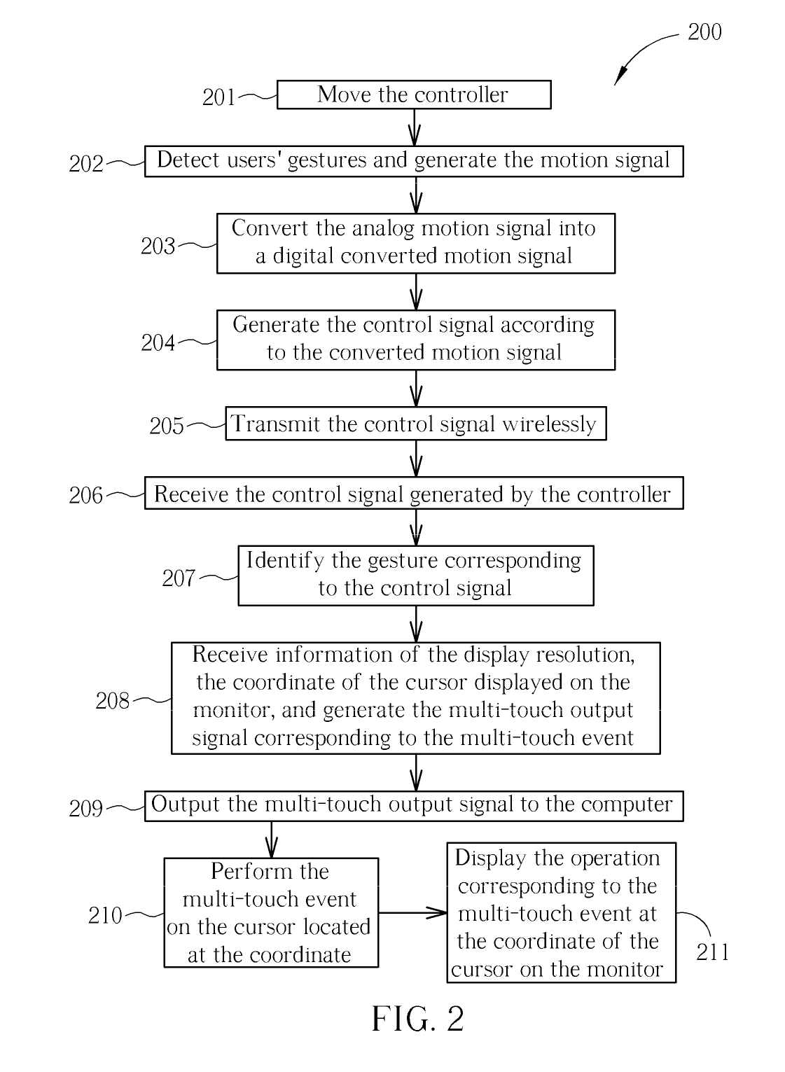

Please refer to FIG. 2. FIG. 2 is a flowchart illustrating a method 200 of wirelessly generating the multi-touch event on the monitor 108 of the computer 102 according to an embodiment of the present invention. The method 200 is accomplished by the help of the controller 104 and the dongle 106, therefore the following paragraph related to the method 200 is described in conjunction with the controlling system 100 for brevity. Provided that substantially the same result is achieved, the steps of the flowchart shown in FIG. 2 need not be in the exact order shown and need not be contiguous. That is, other steps can be intermediate. The method 200 comprises the steps of:

Step 201: Move the controller 104;

Step 202: Utilize the motion sensor 1042 of the controller 104 to detect users' gestures and generate the motion signal Sm;

Step 203: Utilize the converter 1044 (e.g., an analog-to-digital converter) to convert the analog motion signal Sm into a digital converted motion signal Scm;

Step 204: Utilize the first processing unit 1046 to generate the control signal Sc according to the converted motion signal Scm;

Step 205: Utilize the wireless module 1048 (i.e., a transmitter) to transmit the control signal Sc wirelessly;

Step 206: Utilize the receiver 1062 to receive the control signal Sc generated by the controller 104;

Step 207: Utilize the second processing unit 1064 to identify the gesture corresponding to the control signal Sc;

Step 208: Receive information of the display resolution Sre from the computer 102, receive the coordinate Sco of the cursor displayed on the monitor 106 of the computer 102, and utilize the second processing unit 1064 to generate the multi-touch output signal Smco corresponding to the multi-touch event corresponding to the coordinate Sco of the cursor;

Step 209: Utilize the data port 1066 to output the multi-touch output signal Smco to the computer 102;

Step 210: Receive the multi-touch output signal Smco through the data port 1066 and perform the multi-touch event on the cursor located at the coordinate Sco;

Step 211: Utilize the monitor 108 to display the operation corresponding to the multi-touch event at the coordinate Sco of the cursor on the monitor 108.

It should be noted that the second processing unit 1064 performs the initialization operation to declare that the dongle 106 is a multi-touch panel once the dongle 106 is plugged in to the computer 102, since the monitor 108 of the computer 102 may not be a multi-touch screen. In other words, the dongle 106 is a virtual multi-touch screen of the computer 102 after the initialization operation. When the user needs to perform a multi-touch event upon the cursor on the monitor 108, the user moves/waves the controller 104 with a corresponding gesture. Then, the motion sensor 1042 in conjunction with the converter 1044 of the controller 104 extracts the user's gesture to generate the converted motion signal Scm. Then, the first processing unit 1046 processes the converted motion signal Scm to generate the control signal Sc. Then, the wireless module 1048 transmits the control signal Sc to the dongle 106. The dongle 106 is responsible to decode the control signal Sc and to generate the multi-touch output signal Smco having the format similar to the multi-touch output signal that is generated by a real multi-touch panel.

On the other hand, the wireless receiver 1062 of the dongle 106 receives the control signal Sc, and the second processing unit 1064 identifies the gesture corresponding to the control signal Sc. Once the gesture is identified, the corresponding multi-touch event can be generated. In addition, the second processing unit 1064 further receives information of the display resolution Sre of the monitor 108 through the data port 1066. This is because the resolution of the virtual multi-touch screen may be different from the resolution of the monitor 108, thus the second processing unit 1064 converts the multi-touch control signal under the resolution of the virtual multi-touch screen into the multi-touch output signal Smco under the resolution of the monitor 108. In addition, the computer 102 may execute a cursor analysis program to convert the absolute cursor position of a cursor on the monitor 108 into the current coordinate Sco. The second processing unit 1064 continuously receives the current coordinate Sco of the cursor displayed on the monitor 106 through the data port 1066. Then, the second processing unit 1064 generates the multi-touch output signal Smco corresponding to the current coordinate Sco of the cursor. Then, the computer 102 receives the multi-touch output signal Smco through the data port 1066 and performs the multi-touch event upon the cursor located at the current coordinate Sco. Then, the monitor 108 displays the operation corresponding to the multi-touch event on the current coordinate Sco of the cursor on the monitor 108. For example, the operation may be dragging, zooming in/out, or rotating a picture overlapped with the cursor.

According to the present invention, the motion sensor 1042 may be implemented by at least one of a gyro, a g-sensor or the like. In one embodiment, the motion sensor 1042 determines the gestures by the following rules:
a) When “Speed X>+Vectors” and “Speed Y<½ Speed X”, the motion sensor 1042 determines that the controller 104 is moving to the right.
b) When “Speed X<−Vectors” and “Speed Y>½ Speed X”; the motion sensor 1042 determines that the controller 104 is moving to the left.
c) When “Speed Y<−Vectors” and “Speed X>½ Speed Y”, the motion sensor 1042 determines that the controller 104 is moving upwards.
d) When “Speed Y>+Vectors” and “Speed X<½ Speed Y”, the motion sensor 1042 determines that the controller 104 is moving downwards.

Accordingly, when the user holds the controller 104, certain gestures may be provided (not limited to the following):

Up: Rotate the wrist/arm upward.

Down: Rotate the wrist/arm downward.

Right: Rotate the wrist/arm to the right.

Left: Rotate the wrist/arm to the left.

Clockwise rotation: Rotate the wrist clockwise.

Counter clockwise rotation: Rotate the wrist counter clockwise.

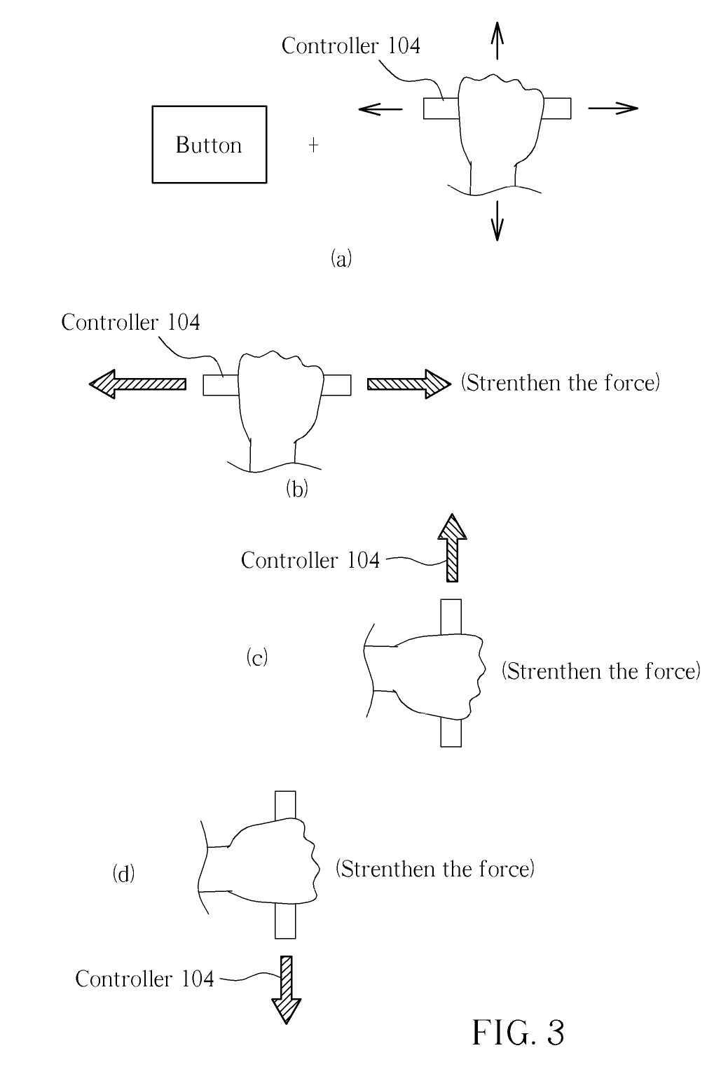

Dragging: Click the button (i.e., the above-mentioned button which is utilized for generating the auxiliary signal Sau) one time and then hold the button (in order to show the cursor) to move up/down/right/left, as shown in FIG. 3(a).

Scrolling: Click the button one time and then shake right/left without holding the button, as shown in FIG. 3(b).

Page up: Click the button one time and then shake up without holding the button, as shown in FIG. 3(c).

Page down: Click the button one time and then shake down without holding the button, as shown in FIG. 3(d).

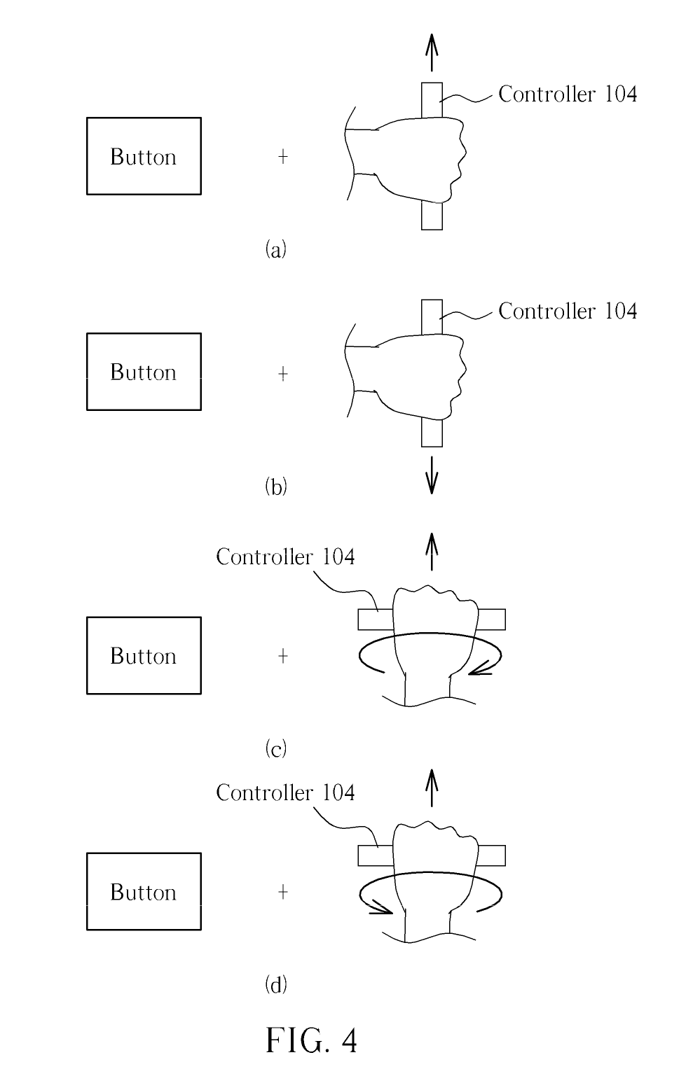

Zoom in: Hold the button until the square cursor is shown on the monitor 108, then move up, as shown in FIG. 4(a).

Zoom Out: Hold the button until the square cursor is shown on the monitor 108, then move down, as shown in FIG. 4(b).

Rotate (clockwise): Hold the button until the square cursor is shown on the monitor 108, then move clockwise, as shown in FIG. 4(c).

Rotate (anticlockwise): Hold the button until the square cursor is shown on the monitor 108, then move anticlockwise, as shown in FIG. 4(d).

Therefore, the monitor 108 of the computer 102 may consist of, but is not limited to, a normal panel. The monitor 108 of the computer 102 can also be consisted of a touch panel. The present invention thus provides a simulation package which transforms the normal display with the normal panel to act as a touch panel together with the controller 104, and thus users may be able to apply the normal panel to use the multi-touch functions provided by, for example, Windows 7, as a touch panel. Furthermore, the motion sensor 1042 may be designed to interpret/track/record users' motions and/or detect/measure users' gestures. Examples of the motion sensor 1042 may include, but are not limited to, a gyro, a g-sensor or the like. The dongle 106 may be portable and convenient for users to carry. The control signal Sc derived from the motion signal Sm, which is generated by the motion sensor 1042, may be sent to the receiver 1062. Moreover, the dongle 106 may include a micro processor (i.e., the second processing unit 1064) and a program stored in a memory (i.e., an SRAM). The program may be capable of being executed by the micro processor to simulate actions/motions of one finger and/or two fingers defined in the multi-touch functions/applications provided by Windows 7. In other words, the dongle 106 may receive the control signal Sc generated by the controller 104 and converts the control signal Sc to the multi-touch control signal Smco which simulates the motion control complying with the multi-touch functions/applications. After applying the above configuration, users' normal panel may function as a touch panel. Consequently, the motion produced by the users can be simulated as the finger motions and can be further applied to control as the way who controls the multi-touch panel only by the help of the controller 106 and the dongle 106 of the present invention, regardless of whether the users have a computer/laptop comprising a multi-touch panel or not.

Briefly, the present invention utilizes a wireless controller 104 and a dongle 106 to act as a virtual multi-touch panel for the computer 102 and to generate the multi-touch control signal (i.e., Smco) for the computer 102. Therefore, the present invention can be applied to different types of displays without the multi-touch panel, from both small size to large size displays, such as displays of a TRC TV, TFT-LCD TV, PC, laptop and projector. The present invention also allows users to use the controller 104 from a long distance, i.e. in a meeting/conference; users may apply the controller 104 to guiding the display of a projector. The user may also use the controller 104 at a short distance, i.e. users may be sitting on the chair, and apply the controller to guiding the display of a computer right in front of the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dongle, comprising:
a receiver, for receiving a control signal which is not generated from a multi-touch panel;
a processing unit, coupled to the receiver, for generating a multi-touch output signal corresponding to a multi-touch event according to the control signal; and
a data port, coupled to the processing unit, for outputting the multi-touch output signal.

2. The dongle of claim 1, wherein the control signal comprises movement information of a transmitter transmitting the control signal.

3. The dongle of claim 2, wherein the processing unit converts the control signal into the multi-touch output signal according to at least a display resolution of a monitor.

4. The dongle of claim 3, wherein when the dongle is coupled to a host through the data port, the data port further receives information of the display resolution from the host.

5. The dongle of claim 3, wherein the processing unit converts the control signal into the multi-touch output signal according to the display resolution of the monitor and a coordinate of a cursor displayed on the monitor.

6. The dongle of claim 5, wherein when the dongle is coupled to a host through the data port, the data port further receives information of the coordinate of the cursor from the host.

7. The dongle of claim 2, wherein the control signal further comprises an auxiliary signal generated from the transmitter, and the processing unit generates the multi-touch output signal according to a combination of the auxiliary signal and the movement information.

8. The dongle of claim 1, wherein when the dongle is coupled to a host through the data port, the processing unit further performs an initialization operation to declare that the dongle is a multi-touch panel.

9. The dongle of claim 1, wherein the receiver is a wireless receiver, and the data port is a universal serial bus (USB) port.

10. A controlling system, comprising:
a controller, for generating a control signal according to movement information of the controller; and
a dongle, for receiving the control signal and outputting a multi-touch output signal according to the control signal.

11. The controlling system of claim 10, wherein the controller generates the control signal further according to an auxiliary signal of the controller.

12. The controlling system of claim 10, wherein the controller comprises:
a motion sensor, for sensing a movement of the controller to generate a motion signal;
a converter, coupled to the motion sensor, for converting the motion signal into a converted motion signal;
a processing unit, coupled to the converter, for generating the control signal according to the converted motion signal; and
a transmitter, coupled to the processing unit, for wirelessly transmitting the control signal to the dongle.

13. A method of generating a multi-touch output signal, comprising:
receiving a control signal which is not generated from a multi-touch panel;
generating the multi-touch output signal corresponding to a multi-touch event according to the control signal; and
outputting the multi-touch output signal.

14. The method of claim 13, wherein the control signal comprises movement information of a transmitter transmitting the control signal.

15. The method of claim 13, wherein the step of generating the multi-touch output signal comprises:
converting the control signal into the multi-touch output signal according to at least a display resolution of a monitor.

16. The method of claim 15, wherein the step of generating the multi-touch output signal further comprises:
receiving information of the display resolution from a host.

17. The method of claim 15, wherein the step of generating the multi-touch output signal comprises:
converting the control signal into the multi-touch output signal according to the display resolution of the monitor and a coordinate of a cursor displayed on the monitor.

18. The method of claim 17, wherein the step of generating the multi-touch output signal further comprises:
receiving information of the coordinate of the cursor from a host.

19. The method of claim 14, wherein the control signal further comprises an auxiliary signal generated from the transmitter, and the step of generating the multi-touch output signal comprises:
generating the multi-touch output signal according to a combination of the auxiliary signal and the movement information.

20. The method of claim 13, wherein the step of receiving the control signal comprises:
wirelessly receiving the control signal; and
the step of outputting the multi-touch output signal comprises:
utilizing a Universal Serial Bus (USB) port to output the multi-touch output signal.
